(19) United States
(12) Patent Application Publication
(10) Pub. No.: US 2018/0186416 A1
(43) Pub. Date: Jul. 5, 2018

(54) METHOD AND APPARATUS FOR SIMULTANEOUS APPLICATION OF SURFACE TREATMENT OF VEHICLE COMPONENTS

(71) Applicants: Daniel J. McCormack, Rincon, GA (US); Samuel D. King, Savannah, GA (US); SoonDong Jung, Richmond Hill, GA (US); David J. Klapper, Bluffton, SC (US); Bradley T. Windy, Rincon, GA (US); John A. Hill, Savannah, GA (US); David M. Rulon, Tybee Island, GA (US)

(72) Inventors: Daniel J. McCormack, Rincon, GA (US); Samuel D. King, Savannah, GA (US); SoonDong Jung, Richmond Hill, GA (US); David J. Klapper, Bluffton, SC (US); Bradley T. Windy, Rincon, GA (US); John A. Hill, Savannah, GA (US); David M. Rulon, Tybee Island, GA (US)

(21) Appl. No.: 15/702,639

(22) Filed: Sep. 12, 2017

Related U.S. Application Data
(60) Provisional application No. 62/394,187, filed on Sep. 13, 2016.

(51) Int. Cl. B62D 65/00; C23C 2/06; C23C 2/00

(52) U.S. Cl. CPC B62D 65/00; C23C 2/003; C23C 2/06

(57) ABSTRACT

A method and apparatus for simultaneous application of surface treatment of components such as vehicle components is provided. A plurality of components is affixed via at least one bracket having at least one lifting attachment point, in a manner such that each of the plurality of components does not touch another component of the plurality of components.

### CROSS REFERENCE TO RELATED APPLICATION

The present application claims priority to U.S. provisional patent application Ser. No. 62/394,187, filed Sep. 13, 2016, entitled METHOD AND APPARATUS FOR SIMULTANEOUS APPLICATION OF SURFACE TREATMENT OF VEHICLE COMPONENTS, the entire disclosure of which is hereby incorporated by reference herein.

### FIELD OF THE INVENTION

The present invention relates generally to preparation of components for surface treatment, and more specifically for treating multiple vehicle components at one time.

### BACKGROUND OF THE INVENTION

Surface treatments, such as, for example, hot-dip galvanizing, plating, and e-coating, are used for protecting surfaces from corrosion as well as contributing to aesthetic appeal. These surface treatments are time and labor intensive, and can therefore be costly. For example, galvanizing typically requires transporting components (often via crane) through a sequence of baths, and leaving each component in each bath for a predetermined amount of time and allowing time for drying and cooling. Similarly, e-coating requires first several preparatory baths, next electrically charging the components in a paint emulsion solution, then rinsing the components, and finally baking/curing for an amount of time. The efficiency, and thus cost, of providing surface treatments is related to the time needed to handle each component. For certain small components such as nails or other loose, unconnected components that may be piled into porous containers, the containers are dipped into baths for surface treatment and may be vibrated to induce movement to prevent the components from remaining in contact with each other through the entirety of the bath dip and thereby facilitating complete coverage of each component with the surface treatment material. However, these methods are impractical for larger components for various reasons, primarily the difficulty in preventing uneven or incomplete coverage of the components due to components touching each other in the bath. Thus, larger components are handled individually, adding to the overall cost of the finished component.

The accompanying drawings, which are incorporated in and constitute a part of this specification, illustrate one or more embodiments of the invention and, together with the description, serve to explain the principles of the invention.

### SUMMARY OF THE INVENTION

The present invention recognizes and addresses considerations of prior art constructions and methods. Some example embodiments may provide apparatuses and methods for simultaneous application of surface treatment of vehicle components.

In an example embodiment, a plurality of components is affixed to one or more brackets, wherein at least one bracket has at least one lifting attachment point, in a manner such that each of the plurality of components is not touching another component of the plurality of components. The plurality of components is spaced away from the one or more brackets with spacers.

A method of preparing a plurality of components for simultaneous surface treatment according to an embodiment of the present invention includes a step of spacing the plurality of components so that each of the plurality of components is not touching another component of the plurality of components. A bracket is provided having attachment holes spaced to maintain spacing for the plurality of components in a first and second direction. The plurality of components is attached to the bracket by threaded hardware, spaced in a third direction, away from the bracket, by spacers. The attached plurality of components is transported to a surface treatment provider.

In a further embodiment, an apparatus for securing components for simultaneous surface treatment includes a plurality of vehicle components and at least one bracket attached to each of the plurality of components so that each of the plurality of components is spaced apart from each other component of the plurality of components and so that none of the components of the plurality of components touch each other. A plurality of spacers is respectively disposed between the plurality of components and the at least one bracket. The plurality of spacers have different lengths with respect to each other, so that the spacers dispose the plurality of components in at least two different distances from the at least one bracket. The at least one bracket defines a least one aperture configured to receive a lifting connector.

In a further embodiment, a method for preparing a plurality of components for simultaneous surface treatment includes spacing the components of plurality of components into an arrangement so that each of the plurality of components does not touch another component of the plurality of components, and providing at least one bracket having a plurality of first apertures at which the components are selectively attachable to the bracket. The plurality of components are attached to the at least one bracket so that each component is spaced apart from each other component of the plurality of components in a first direction. The at least one bracket has at least one second aperture configured to receive a lifting connector. Respective spacers are disposed between the components and the brackets so that the components are spaced from the bracket in a second direction that is orthogonal to the first direction. The attached plurality of components is secured at the at least one second aperture, and the attached plurality of components is inserted, while supported at the at least one second aperture, into a surface treatment bath.

In a still further embodiment, method for simultaneous surface treatment of a plurality of vehicle components includes arranging a plurality of vehicle components into an arrangement and rigidly attaching at least one bracket to each vehicle component in the arrangement so that each of the plurality of components is in a fixed position with respect to, and does not touch, each other vehicle component of the plurality of vehicle components. The arrangement is lifted via the at least one bracket and, while supporting the arrangement via the at least one bracket, transporting the arrangement to a surface treatment bath. While supporting the arrangement via the at least one bracket, the arrangement is inserted into a surface treatment bath.

The accompanying drawings, which are incorporated in and constitute a part of this specification, illustrate one or more embodiments of the invention and, together with the description, serve to explain one or more embodiments of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a cluster of rear frames of a trailer arranged for surface treatment in accordance with an embodiment of the present invention;

FIG. 2 is a side view of the cluster as in FIG. 1;

FIG. 3 is a front view of the cluster as in FIG. 1;

FIG. 4 is a partial side view of a bracket attachment for the cluster as in FIG. 1;

FIG. 5 is a partial perspective view of the cluster as in FIG. 1;

FIG. 6 is a section view of the bracket attachment for the cluster; and

FIG. 7 is a flow chart illustrating a method of assembly, transport, and surface treatment of the cluster as in FIG. 1.

Repeat use of reference characters in the present specification and drawings is intended to represent same or analogous features or elements of the invention according to the disclosure.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

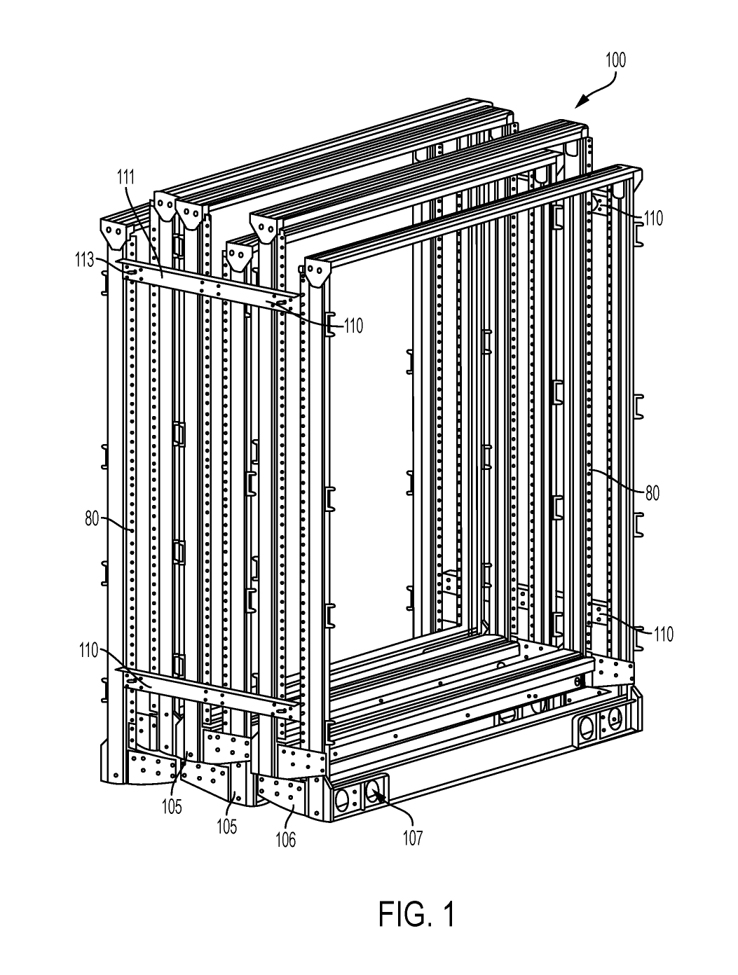

As used herein, terms referring to a direction or a position relative to the orientation of the bracket discussed herein, and/or to a parts cluster secured by such brackets, such as but not limited to “vertical,” “horizontal,” “upper,” “lower,” “above,” or “below,” refer to directions and relative positions with respect to the bracket's and/or cluster's orientation in its normal intended operation, as indicated in FIG. 1 herein, unless otherwise stated. Thus, for instance, the terms “vertical” and “upper” refer to the vertical direction and relative upper position in the perspective of FIG. 1 and should be understood in that context, even with respect to a cluster that may be disposed in a different orientation.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

In the exemplary embodiment shown in the Figures, the components to receive the surface treatment are rear frames for semi-trailers. As should be understood, a rear frame of a semi-trailer is an assembly of formed steel (or other suitable metal) members that attach to the trailer's floor, side walls, and roof to thereby frame the trailer's rear opening and provide support for attachment of the trailer's rear door(s). It should be understood, however, that various other components, including other components of a semi-trailer such as upper couplers, deck assemblies, support gear or landing gear, or rear impact guard assemblies, may be prepared for and surface treated using apparatuses and methods consistent with embodiments of the present disclosure.

Referring now to FIG. 1, a cluster of parts for dipping 100 includes a plurality of rear frames 105 fixed in position with respect to each other by four brackets 110 to which the rear frames are rigidly attached. Each rear frame 105 is comprised of four elongated formed members in a rectangular frame so that the members' elongation dimensions are generally coplanar. In terms of such planes of the frames, the frames are oriented approximately parallel to each other to thereby minimize spacings between the rear frames and minimize the overall dimensions of the cluster of rear frames. Reduction in the overall cluster dimension in turn increases the number of rear frames 105 that can be treated in a single batch.

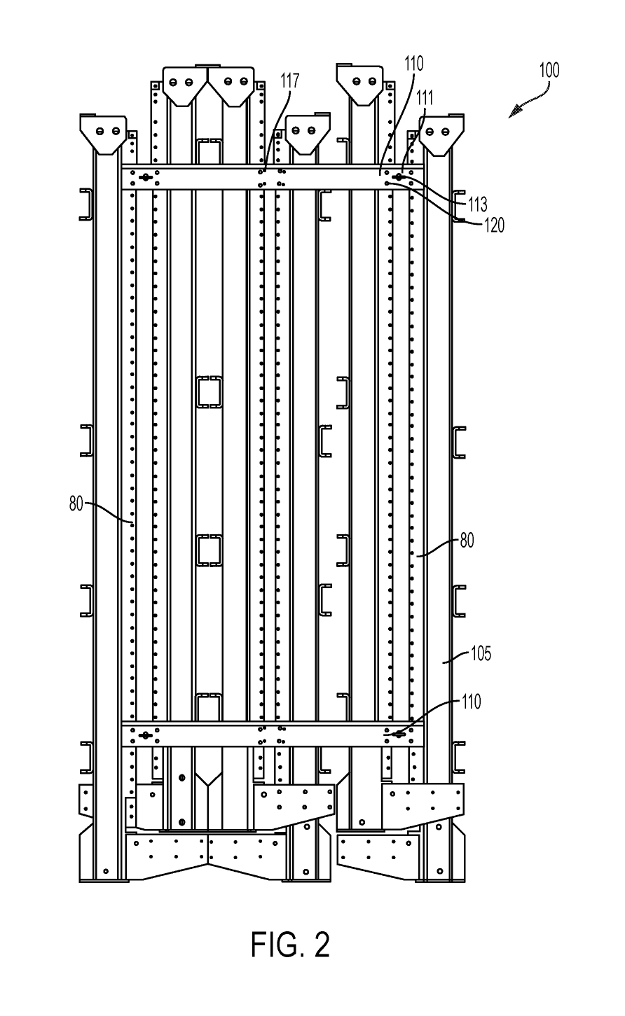

In various embodiments, the orientation of the components with respect to each other within the cluster may be selected (via selection of how the components are secured within the cluster with respect to each other by the brackets) in order to maximize the number of components that may be simultaneously surface-treated. For example, the limiting dimension for treating cluster 100 may be the width of a zinc bath. Thus, the components may be attached to brackets 110 in the generally co-planar arrangement shown in FIG. 1, which minimizes the cluster's dimension in the elongation direction of brackets 110. Assuming the number of frames in the cluster is such that the cluster's dimension in the brackets' elongation direction (i.e. the horizontal dimension indicated in FIG. 2) is shorter than the cluster's other two orthogonal dimensions, selection of the maximum number of frames in such arrangement within the zinc bath's width maximizes the number of components that can be simultaneously treated in the bath, assuming the other cluster dimensions are non-limiting. Alternatively, it will be noted in the arrangement of FIG. 1 that the frames are attached to brackets 110 so that the frames are staggered with respect to each other in the vertical direction, in order to reduce an overlap of bottom plates 106 that could reduce the bath's effectiveness in treating the areas of the bottom plates. However, if the limiting dimension of a surface treatment process is the height of cluster 100, the components may, if needed, be rearranged in their attachments to the brackets so that the components are vertically aligned with each other, i.e. eliminating the relative vertical offsets.

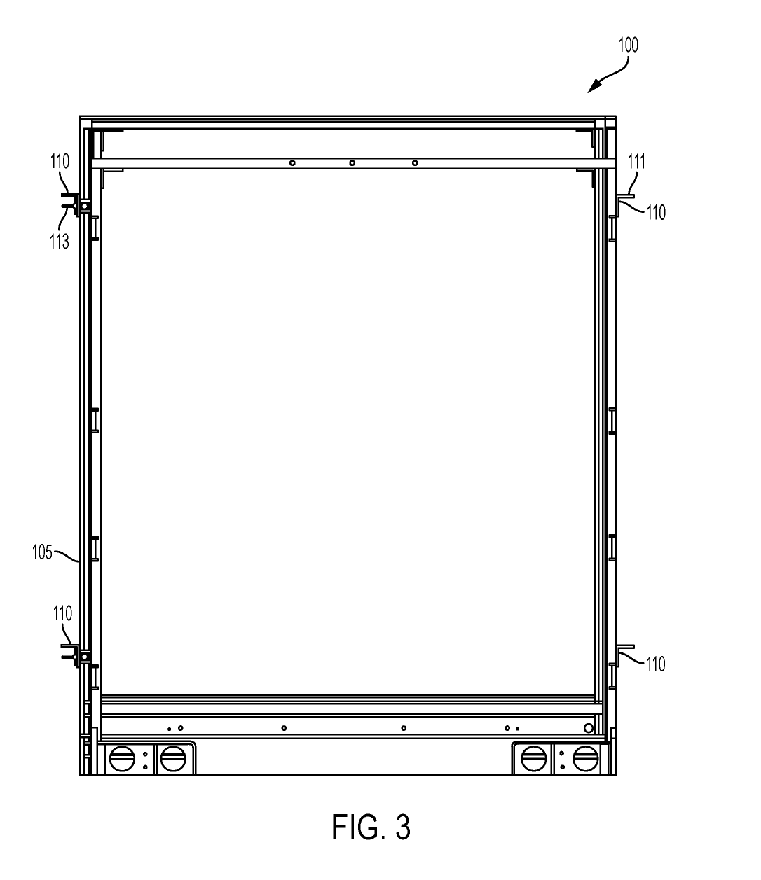

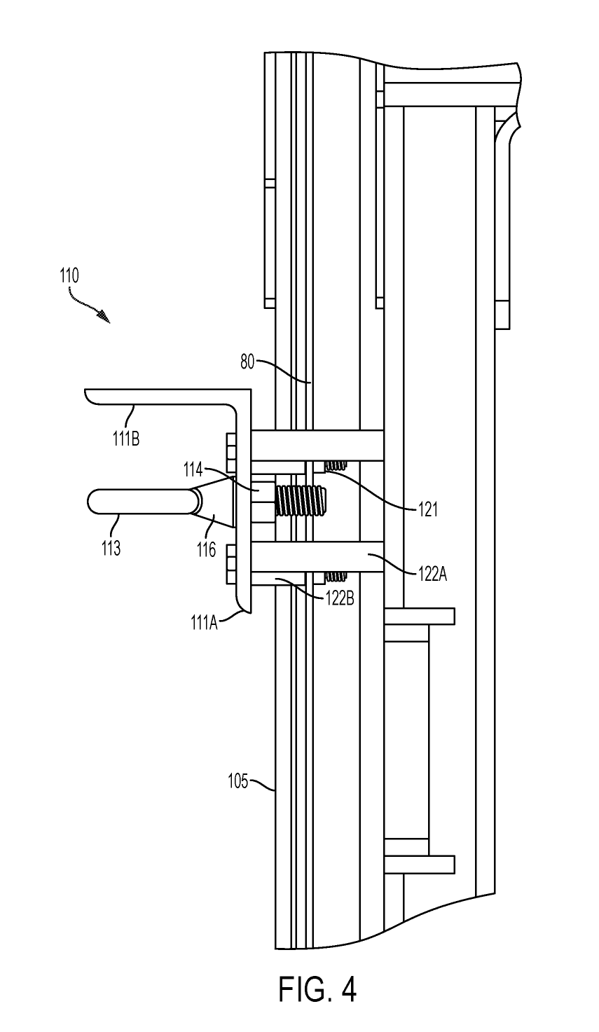

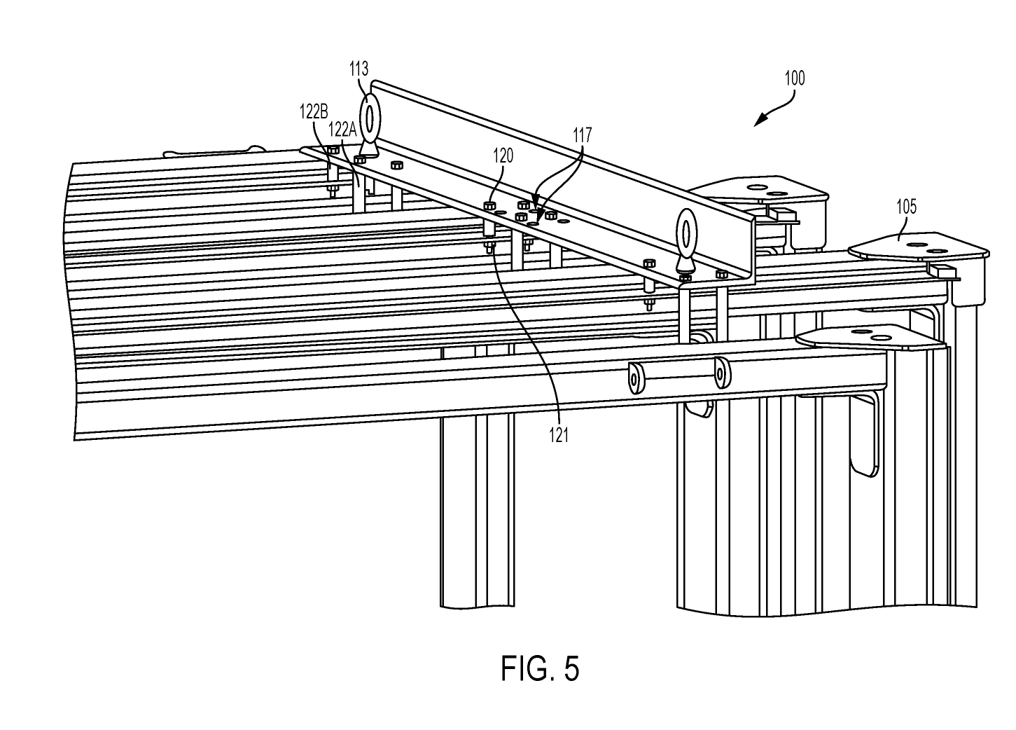

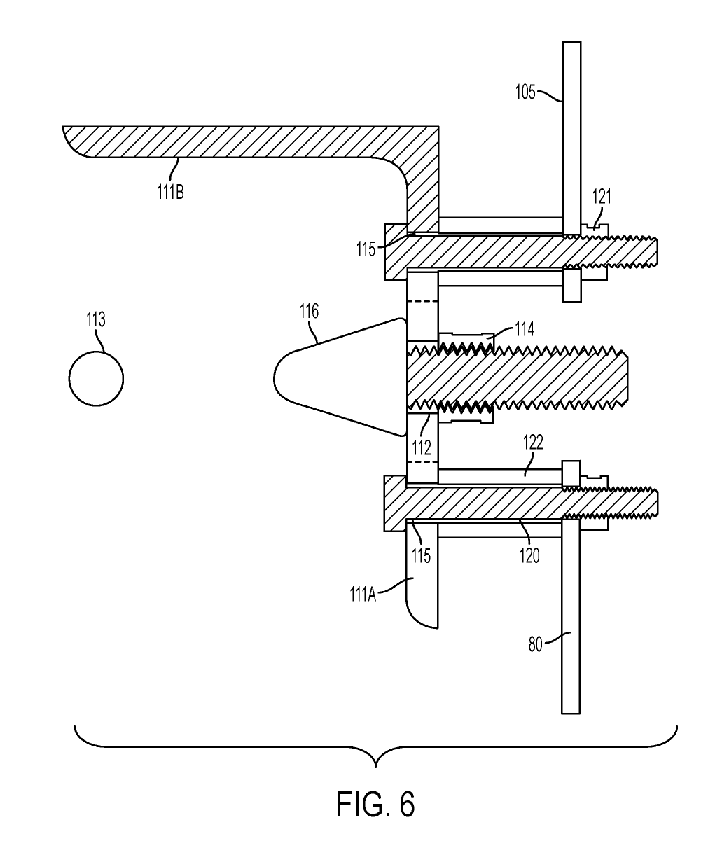

Referring to FIGS. 1, 4, and 5, bracket 110 comprises an L-shaped angle member 111 (in vertical cross-sections, in the view of FIG. 1) having a lower generally planar portion or leg 111A, through which a plurality of through-holes extend in a direction perpendicular to the plane of leg 111A, and an upper generally planar portion or leg 111B extending perpendicular to leg 110A and without through-holes. Angle member 111 may be constructed of formed steel such as stainless steel, galvanized steel, or other metal such as aluminum, etc. Referring also to FIG. 6, the front side (shown as the left side in FIGS. 1, 3, 4 and 6) of lower leg 111A defines two non-threaded through-holes 112, each approximately midway along the vertical length of leg 111A and on opposite ends of the elongation dimension (shown as the horizontal dimension in FIG. 2) of bracket 110. The two holes 112 receive respective eye hooks 113, each of which passes through its respective hole 112 and is held in place with respect to the bracket by a respective threaded nut 114. To provide structural integrity, in the illustrated embodiment, eye hooks 113 are cast, as fabricated wire eye hooks can open up under large loads. Additionally, eye hooks 113 have respective base flanges 116 that seat against the outer face of leg 111A and thereby further increase the structural integrity of eye hooks 113. Each eye hook 113 is formed by a metal loop in a generally circular shape that encloses a through aperture and that surrounds an axis perpendicular to the plane of the loop and is oriented such that the axis is vertical as indicated in FIG. 1. The aperture of each eye hook 113, which may be considered to encompass the metal loop about the aperture, is of a sufficient size to receive a lifting device such as a hook at the end of a cable or strap on a crane. The eye hooks thereby serve as attachment points for lifting, transporting, and orienting cluster 100 during the surface treatment as well as to and from the surface treatment provider. Brackets 110 on the rear side (opposite the front side, shown as the right side in FIG. 3) do not have eye hooks, although in other embodiments they do.

A plurality of through-holes 115 extending horizontally through lower legs 111A serve as attachment holes for receiving mounting hardware (bolts 120) to attach bracket 110 to each of rear frames 105. Each rear frame has a pair of vertically-oriented flanges 80 that extend forward from respective forward (from the perspective of a trailer) side edges of the rear frame. Each flange defines a plurality of holes that extend horizontally through the flange and that are used to allow passage of screws, rivets, or other attachment mechanisms therethrough to attach the rear frame to a trailer wall or wall structure. Each lower leg 111A defines a plurality of pairs of vertically aligned through-holes extending horizontally through the lower leg. The two holes of each pair are spaced vertically from each other the same distance as are two of the holes through one of the flanges 80, so that the bracket 110 may be placed against a flange 80 so that the two vertically-aligned holes in leg 111A align with an opposing pair of vertically-aligned holes in flange 80. In this example, the through holes in lower leg 111A are of a comparable diameter to the diameter of the through-holes in flanges 80, and in these embodiments a bolt 120 may be passed through each of the two vertically aligned holes in leg 111A and simultaneously through that hole's opposing hole in flange 80 so that a threaded end of the bolt extends inwardly (from the perspective of the enclosure formed by frame 105) from flange 80. A nut 121 may be selectively threaded onto the threaded end of bolt 120 until it seats against the inner side of flange 80 and so that tightening of nut 121 pulls the bolt head on the opposite end of the bolt tight against the outer surface of lower leg 111A. Nuts 121 may be, for example, hex nuts, self-clenching nuts installed within rear frames 105, or in further embodiments, may be threaded portions of rear frame 105. Two bolts 120 extend through each bracket 110 attach that bracket to the rear frame 105, thereby preventing a pivotal attachment between the bracket and each rear frame. Accordingly, when a pair of bolt 120/nut 121 hardware combinations is assembled to attach a rear frame to a bracket, the rear frame is rigidly attached to the bracket due both to the clamping effect of each bolt/nut combination and to the use of two such combinations.

Each pair of vertically-aligned holes 115 (FIG. 6) are horizontally offset from each adjacent pair of vertically aligned holes 115 in order to space and separate adjacent rear frames 105, preventing surfaces of one rear frame 105 from touching an adjacent rear frame 105 and therefore affecting each other's surface treatment. It will be noted that each pair of vertically-aligned holes 115 are nearer to an adjacent pair of holes 115 to one side of the hole pair than to the next adjacent pair of holes 115 on the other side of the hole pair. This arises from the expected arrangement of the rear frames when assembled into the bracketed cluster, in which rear frames 105 are arranged in pairs facing each other in an opposite orientation so that the front flanges 80 of one rear frame of the pair oppose the front flanges 80 of the other rear frame of the pair. Thus, considering each rear frame 105 and its flange 80, a flange 80 of the rear frame 105 next adjacent the rear frame on one side will be directly opposite that flange 80, but the flange 80 of the rear frame on the other side will be further away. Thus, as is indicated in the Figures, each pair of vertically aligned holes 115 is closely proximate the next pair of vertically aligned holes 115 on one side but is further separated from the next pair of vertically aligned holes 115 on the other side. Thus, it will be understood that holes 115 through lower leg 111A are arranged in a manner with respect to the other pairs of through holes 115 through leg 11A to correspond to the placement of the several rear frames to which the brackets are attached and that other arrangements of through holes 115 may be utilized depending on the arrangement of other parts that may be secured by the brackets. Moreover, it should also be understood that a matrix of through-holes may be provided on each lower leg 111A so that the brackets may accommodate various different types of parts.

As indicated in FIG. 2, each pair of vertically-aligned holes 115 (FIG. 6) is shifted in the vertical direction with respect to its next-closest pair of vertically aligned holes 115. As is apparent from FIG. 2, components respectively attached to these next closest pairs of holes 115 are attached to bracket 110 (via bolts extending through holes 115 and the holes in flanges 80, as discussed above) so that they are vertically shifted with respect to each other. This relative shift between the components 105 increases the overall vertical dimension of the cluster from what it would be if there were no relative vertical shift among the components. Accordingly, with regard to the two components 105 respectively attached to the two next-closest hole pairs 115, attaching the higher of the two relatively-vertically-shifted components 105 to the lower of the two hole pairs, as is shown in FIG. 2, reduces the impact of the relative vertical shift between the two adjacent components on overall cluster height. That is, the relative vertical shift between the next-closest holes 115 in this arrangement reduces the overall height of the cluster from what it would be if the two hole pairs 115 were not vertically offset, i.e. were aligned with each other horizontally.

Further, bracket 110 comprises a pair of vertically-aligned through-holes 117 immediately beside each pair of through holes 115, but shifted vertically with respect to that pair of through-holes 115 so that the pair of through-holes 117 is aligned horizontally with the next closest pair of vertically aligned through-holes 115. A similar set of vertically-aligned through-holes 117 is provided immediately beside that next closest pair of vertically-aligned through-holes 115, such that the second pair of holes 117 is aligned horizontally with the first pair of through-holes 115, such that the two pairs of through-holes 117 has the same horizontal spacing as do the two pair of through-holes 115, but so that the two pair of holes 117 have the opposite vertical shift with respect to each other than do the two pair of through-holes 115. Since flanges 80 on either side of a frame 105 are aligned so that the respective pairs of opposing holes through opposing flanges 80 are aligned with each other horizontally (in the direction in and out of the page of FIG. 2), the shadow sets of holes 115/117 allow the same bracket to be used on either side of the cluster and attach to the frames at the same vertical level on the cluster, aligned horizontally with a bracket on the opposite side of the cluster. In certain embodiments, hole pairs 117 are not provided adjacent to the other dual pairs of holes 115 (i.e. those hole pairs 115 offset from the center of bracket 110) because when a bracket 110 is turned around to be attached to the other side of the cluster, the shift in holes 115 at the bracket edges inherently align in their vertical offsets with the holes of the bracket on the other side of the cluster. In other embodiments, however, the additional hole pairs are nonetheless provided for the end hole pairs, in the same horizontal shift present between holes 115 and 117 in the center hole group, to thereby maintain consistent horizontal spacing among the hole groups and assure that bracket 110 aligns properly with the holes in the components 105 regardless at which side of the cluster the bracket is used.

It will be noted that the two holes of each pair of vertically aligned holes 115 (and 117) are disposed so that, considering a common line passing through both centers of the two holes, the common line is disposed at a 0° angle with respect to vertical. In other embodiments, this common line through each such hole pair is disposed at an acute, non-zero angle with respect to vertical (assuming the elongation dimension of the bracket 110 is aligned at zero degrees with respect to horizontal), with the common lines of all the hole pairs 115 and 117 being parallel to each other. Assuming brackets 110 are attached to the cluster relatively near to the top or bottom of the cluster, so that it would be impossible to introduce a consistent step-up or step-down in vertical shift of components 105 from one component 105 to its next adjacent component 105 in the cluster, moving horizontally from one side of the cluster or the other, the non-zero angle (with respect to vertical) of the vertically aligned holes 115 (and 117) allows the brackets 110 to be attached to the cluster members 105 so that if components 105 remain vertically-oriented and each hole pair 115/117 are also aligned at zero degrees with respect to vertical as they are attached to corresponding vertically aligned holes in the components, the elongation dimension of each bracket 110 is aligned at the non-zero angle, but with respect to horizontal rather than vertical. If, as described below, a crane picks up the brackets 110 and lifts the cluster so that the elongation dimension of the brackets 110 are aligned at a zero degree angle with respect to horizontal, the components 105 are disposed so that their elongation dimensions are at the non-zero angle with respect to vertical.

While each bolt 120 is shown with several threads extending through nut 121, further embodiments may implement shorter bolts so that the threaded end of each bolt 120 ends within or flush with the edge of a nut 121 when the rear frames are assembled into a cluster with the brackets.

Bolts 120 are inserted through standoffs 122, which are cylindrical bushings and which space rear frames 105 from brackets 110 such that brackets 110 do not touch frames 105 and thus interfere with the surface treatment of the frame. With a standoff 122 between a bracket and a rear frame surface, and an insertion of a bolt 120 through the assembly, a tightening of a nut 121 on an end of the bolt 120 causes the bolt head to pull towards nut 121, pressing leg 111A and flange 80 of rear frame towards each other and against standoff 122. Further, standoffs 122A and 122B of different lengths are used at respective pairs of adjacent holes 115 to stagger rear frames 105 in the lateral or horizontal direction (perpendicular to the longitudinal direction of the brackets 110) with respect to each other, enabling both more-compact configurations and preventing surfaces of one rear frame 105 from touching another rear frame 105 and therefore affecting its surface treatment. Consider, for instance, the flanges 106 extending forwardly from the main portion of each frame 105. If the frames are attached to the brackets 110 at a horizontal distance between adjacent frames 105 that is less then twice the horizontal dimension of flanges 106, then the flanges 106 of adjacent frames 105 may interfere with each other (assuming that adjacent frames 105 are attached to the bracket facing each other) if the frames are aligned with each other in the vertical dimension and in the dimension coming into and out of the page in the view of FIG. 2. To avoid interference between the flanges, adjacent frames 105 that face each other may be offset from each other in the vertical dimension, as indicated in FIG. 2, but may alternatively be offset from each other in the dimension into and out of the page in the perspective of FIG. 2. During the surface treatment process, portions of the frame surface covered by standoffs 122 may not be treated. As such, secondary processes may be used to touch-up such untreated portions. Alternatively, when rear frames 105 are incorporated into an assembled trailer, such untreated portions may be covered by hardware, so that untreated portions are not visible or subjected to elements for which the surface treatment might protect.

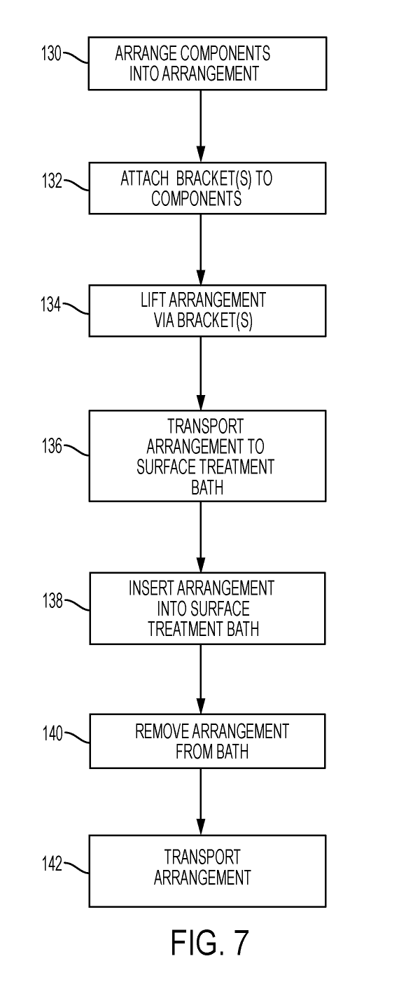

Referring to FIGS. 1, 5, and 7, when arranging cluster 100 for attachment to the brackets at a step 130, a rack or fixture may be used to orient the unattached rear frames 105 in a desired configuration for attaching to bracket 110. The rack may utilize characteristic features of rear frames 105 to orient the rear frames 105 in the desired configuration. The rack may have cutouts, for example, to receive parts of rear frames (e.g. flanges 106, shown in FIG. 1) that protrude outward from the main, generally planar portion of the frames and that therefore provide a place at which to secure the frame. Further, the rack may have protrusions to support rear frames 105, e.g. through tail light holes 107, to hold the frames in place for attachment of the brackets. Alternatively, the rack may simply be a pair of horizontally parallel bars upon which the frames may be hung and slidably moved toward and away from each other. As the four brackets are attached to the flanges 80 of one frame, the next frame may be moved into position to be attached to the brackets, and possibly lifted slightly (or the first frame, and therefore the brackets, lifted slightly) before the brackets are attached to the next frame, to effect a relative vertical offset between the two frames. Still further, as the illustrated embodiment shows rear frames 105 in vertically-offset positions with respect to each other, the rack may have supports for vertically offsetting rear frames 105. In this way, the rack may provide stability as well as guide a user in properly orienting rear frames 105 in the cluster with respect to each other prior to attachment of brackets 110. Once rear frames 105 are oriented on the rack, brackets 110 may be attached to the rear frames, as indicted at step 132 at FIG. 7, with bolts 120, nuts 121, and standoffs 122. Once brackets 110 are attached, cluster 100 may be removed from the rack and shipped as a single, cohesive unit. By holding rear frames 105 in a rack, cluster 100 may be more efficiently assembled.

The use of brackets 110 to secure a plurality of frames 105 by such or other suitable manner into fixed positions with respect to each other on the brackets allows the brackets to be positioned relatively closely to each other, but not touching each other, thereby creating a cluster of proximate frames on the brackets in a relatively close formation that maximizes the number of frames within the cluster while minimizing the overall dimensions of the cluster. The cluster allows rear frames 105 to be efficiently delivered to the surface treatment provider in that cluster 100 may be transported from the manufacturing facility, treated at the surface treatment facility, and returned to the manufacturing facility without assembling, disassembling, or individually packing each frame. Further, cluster 100 has a more stable base than single, unattached rear frames 105, as the base area to height ratio of cluster 100 is greater than that of a single rear frame, making cluster 100 easier to stack, store, and transport. Moreover, brackets 110 and eye hooks 113 may provide lifting points for cranes, fork lifts, etc. for transporting rear frames 105 and provide attachment points for tie down straps to attach to the cluster so that the tie down straps may be secured at their opposite ends to the deck or side of a trailer or truck bed to thereby secure the cluster on the truck or trailer for transport.

Accordingly, once a cluster of frames has been assembled as discussed above at steps 130 and 132, hooks attached to cables or straps are secured to the two eye hooks on each of the two upper brackets 110 on either side of the cluster, and the four straps or cables are secured on their other end to a crane, forklift, or other lifting device, and the cluster is lifted, at step 134, and moved by the lifting device to a truck or trailer, at which tie down straps are attached at the eye hooks and the truck or trailer deck or sides to secure the cluster to the truck or trailer for transport. The truck or trailer transports the cluster, as indicated at step 136, to a location at which the cluster is to be surface treated, at which a crane, forklift, or other lifting device is secured to the cluster by cables or straps and associated hooks through the eye hooks in the same manner as at the point of origin. The lifting device lifts the cluster off of the truck or trailer and transports the cluster to a staging area (or directly to the dipping bath). At the staging area, a similar crane, forklift, or other lifting device is similarly attached to the cluster, lifts the cluster, and transports the cluster to the dipping bath.

Using galvanizing as an example of a surface treatment, cluster 100 may be galvanized by successively dipping cluster 100 into a series of baths, as indicated at step 138, beginning with a series of pre-treatments, followed by a zinc bath, and then left to cool. Typically, a crane is used to dip items in each bath as well as transport items from one bath to another. By providing eye hooks 113, the crane may easily attach to cluster 100, as described above, for dipping and transporting by securing cables or straps to the eye hooks and then attaching the opposing, unattached ends of the cables or straps to the crane. Additionally, when dipping the cluster, operators may prefer to orient cluster 100 so that an edge or corner of the cluster, rather than the full bottom of the cluster first enters the bath surface. Assume, for example, that the crane cables are attached to the four eye hooks of the two upper brackets 110. To dip the leading end of the cluster, the crane operator manipulates the crane to lower the forward two eye hooks (i.e. the two eye hooks that oppose each other on the two opposing upper brackets 110 on either side of the cluster) with respect to the rearward two eye hooks, causing the cluster to tilt downward in the front with respect to the back so that the elongation dimension of brackets 110 define a non-zero angle (hereinafter “dipping angle”) with respect to the plane of the bath surface. Further, an operator may dip cluster 100 through (i.e. move the cluster into, through, and out of) the bath at a predetermined desired rate of movement or speed. By providing a plurality of substantially spaced eye hooks 113, the crane may more easily orient and control the dipping process.

When cluster 100 hangs by eye hooks 113, leg 111B serves to provide structural rigidity. In certain embodiments, the eye hooks extend sufficiently laterally from the major bracket surfaces that neither the crane hook at the need of cable/chain, nor the cable/chain itself, presses or drags against leg 111B. Eye hooks 113 may protrude a sufficient distance such that when a crane hooks to it and cluster 100 is oriented at the dipping angle, the crane hook and its attached cable do not touch leg 111B. Alternatively, as both legs 111B on brackets 110 are oriented on the same side (the top side according to FIG. 3) cluster 100 may be oriented at the dipping angle so that the hook and attached cable tilt away from upper legs 111B (i.e. with the top right corner in FIG. 3 at the lowest elevation).

Once the surface treatment process is completed and cluster 110 is removed from the bath, as indicated at step 140, by the crane, forklift, or other transport device, the transport device transports the cluster to a staging location, and from there to a truck or trailer, at which the cluster can be secured to the truck or trailer as described above. The cluster is then transported by truck or truck/trailer, as indicated at step 142, to a place where the cluster components can be used (e.g., a manufacturing plant for final assembly). At this location, cluster 100 may be removed from the truck or trailer by a similar forklift, crane or other lifting device and moved to a manufacturing floor, where the cluster may be dismantled by removing screws or bolts 120 and releasing bracket 110, thereby providing to the manufacturing facility a plurality of independent rear frames 105 with treated surfaces.

While one or more preferred embodiments of the invention are described above, it should be appreciated by those skilled in the art that various modifications and variations can be made in the present invention without departing from the scope and spirit thereof. For example, while cluster 100 is shown with six rear frames 105, it should be understood that modifications (e.g., varying the length of bracket 110) could enable more or fewer rear frames 105 to be treated at once. Such modifications enable a person having ordinary skill in the art to create arrangements to optimize surface treating costs. For example, larger baths and/or ovens may be able to accommodate more rear frames 105, while smaller baths and/or ovens may require smaller clusters 100. Additionally, while four brackets 110 are used in the example embodiment, more or fewer brackets 110 may be employed. Further, while one L-shaped angle member profile is shown to be used in bracket 110, further profiles may be employed, including, but not limited to, various other angle geometries (e.g., with longer or shorter, thinner or thicker legs), channels, I-beams, and hollow structural sections and may depend on necessary structural requirements. Moreover, brackets are shown to be attached in parallel at certain locations along the edge of cluster 100, it should be understood that various attachment configurations may be equally functional, and may depend on attachment locations on rear frames 105. As an additional note, while the illustrated embodiment shows cluster 100 with rear frames 105, it should be understood that various embodiments consistent with the present disclosure may be modified for used with other vehicle components as well as components not associated with vehicles, which require surface treatment.

Accordingly, it should be understood that the elements of one embodiment may be combined with another embodiment to create a still further embodiment. It is intended that the present invention cover such modifications and variations as come within the scope and spirit of the present disclosure, the appended claims, and their equivalents.

What is claimed is:

1. An apparatus for securing components for simultaneous surface treatment, comprising:
a plurality of vehicle components;
at least one bracket attached to each of the plurality of vehicle components so that each of the plurality of vehicle components is spaced apart from each other vehicle component of the plurality of vehicle components and so that none of the vehicle components of the plurality of vehicle components touch each other; and
a plurality of spacers respectively disposed between the plurality of vehicle components and the at least one bracket,
wherein the plurality of spacers have different lengths with respect to each other, so that the spacers dispose the plurality of vehicle components in at least two different distances from the at least one bracket, and
wherein the at least one bracket defines a least one aperture configured to receive a lifting connector.

2. The apparatus as in claim 1, wherein the vehicle components are semi-trailer rear frames.

3. A method for preparing a plurality of components for simultaneous surface treatment comprising:
spacing the components of the plurality of components so that no component of the plurality of components touches another component of the plurality of components;
providing at least one bracket having a plurality of first apertures at which the components are selectively attachable to the at least one bracket and attaching the plurality of components to the at least one bracket so that each component of the plurality of components is spaced apart from each other component of the plurality of components in a first direction, wherein the at least one bracket has at least one second aperture configured to receive a lifting connector;
disposing respective spacers between the components of the plurality of components and the at least one bracket so that the components of the plurality of components are spaced from the at least one bracket in a second direction that is orthogonal to the first direction; and
securing the attached plurality of components at the at least one second aperture and inserting the attached plurality of components, while supported at the at least one second aperture, into a surface treatment bath.

4. The method as in claim 3, comprising attaching the plurality of components to the at least one bracket by threaded hardware extending through the spacers.

5. The method as in claim 3, wherein, in the disposing step, at least two of the spacers have different lengths with respect to each other.

6. The method as in claim 3, wherein, in the providing step, the at least one bracket comprises an angle member.

7. The method as in claim 3, wherein, in the providing step, the at least one second aperture is defined by a respective eye hook.

8. The method as in claim 3, wherein, in the inserting step, the surface treatment bath is a component of at least one of a galvanizing, a powder coating, an e-coating, and a plating process.

9. The method as in claim 3, wherein:
the providing step comprises providing two first said brackets and two second said brackets above the first brackets, wherein each of the two second brackets define two said second apertures, and
the attaching step comprises:
attaching the two second brackets to respective opposing sides of the components of the plurality of components, and
attaching the two first brackets to respective opposing sides of the components of the plurality of components.

10. The method as in claim 3, wherein the components of the plurality of components are vehicle components.

11. The method as in claim 10, wherein the vehicle components are rear frames of a semi-trailer.

12. The method as in claim 3, wherein, at the providing step, the plurality of first apertures comprises a first vertically aligned pair of said first apertures and a second vertically aligned pair of said first apertures, wherein the first pair of first apertures is vertically offset from the second pair of first apertures.

13. A method for simultaneous surface treatment of a plurality of vehicle components, comprising:
arranging a plurality of vehicle components into an arrangement;
rigidly attaching at least one bracket to each said vehicle component in the arrangement so that each of the plurality of vehicle components is in a fixed position with respect to, and does not touch, each other vehicle component of the plurality of vehicle components;
lifting the arrangement via the at least one bracket and, while supporting the arrangement via the at least one bracket, transporting the arrangement to a surface treatment bath; and
while supporting the arrangement via the at least one bracket, inserting the arrangement into the surface treatment bath.

14. The method as in claim 13, wherein, at the rigidly attaching step, the at least one bracket has a plurality of first apertures at which the vehicle components of the plurality of vehicle components are selectively attachable to the at least one bracket.

15. The method as in claim 14, wherein, at the rigidly attaching step, the at least one bracket has at least one second aperture configured to receive a lifting connector and wherein the lifting connector is attached to the at least one second aperture at the lifting step and during the transporting step.

16. The method as in claim 13, wherein
the vehicle components of the plurality of vehicle components have a common geometry,
at the rigidly attaching step, the vehicle components of the plurality of vehicle components are attached to the at least one bracket so that two vehicle components of at least one pair of adjacent vehicle components of the plurality of vehicle components are offset with respect to each other in at least one first dimension that is perpendicular to a second dimension, and
each vehicle component of the plurality of vehicle components is spaced from each other vehicle component of the plurality of vehicle components in the second dimension.

17. The method as in claim 16, wherein, at the rigidly attaching step, the vehicle components of the plurality of vehicle components are attached to the at least one bracket so that the plurality of vehicle components define a plurality of said pairs of adjacent vehicle components.

18. The method as in claim 16, comprising disposing respective spacers between the vehicle components of the plurality of vehicle components and the at least one bracket so that the vehicle components are spaced from the at least one bracket in the second dimension.

19. The method as in claim 18, wherein, in the disposing step, at least two of the respective spacers have different lengths with respect to each other.
